(19) United States
(12) Patent Application Publication
(10) Pub. No.: US 2023/0001555 A1
(43) Pub. Date: Jan. 5, 2023

(54) WORKING TOOL

(71) Applicant: Hilti Aktiengesellschaft, Schaan (LI)

(72) Inventors: Chafic ABU ANTOUN, Buchs (CH); Florian SCHMID, Buchs (CH); Albert BINDER, Buchs (CH); Manuel GUT, Göfis (AT)

(21) Appl. No.: 17/782,041

(22) PCT Filed: Dec. 10, 2020
(86) PCT No.: PCT/EP2020/085440

§ 371 Date: Jun. 2, 2022

(30) Foreign Application Priority Data
Dec. 20, 2019 (EP) 19218901.7

(51) Int. Cl. B25C 1/06; H02K 11/00; H02K 33/12; H02P 1/44

(52) U.S. Cl. CPC B25C 1/06; H02K 11/0094; H02K 33/12; H02P 1/445

(57) ABSTRACT

A tool for working a substrate has a stator and a working piston, which is intended to move relative to the stator along a working axis, also having a drive, which is intended to drive the working piston from a starting position along the working axis to the substrate, the drive comprising a piston coil arranged on the working piston and a first stator coil arranged on the stator, and the first piston coil being intended to enter the first stator coil during a movement of the working piston relative to the stator along the working axis.

The present invention relates to a tool, such as for example a setting tool for driving fastening elements into a substrate.

Such tools often have a working piston, which is intended to move along a working axis. The working piston is driven by a drive, which accelerates the working piston. WO 2018/104406 A1 describes a drive, which has an electrical capacitor, a squirrel-cage rotor arranged on the working piston and an excitation coil, which during rapid discharge of the capacitor is flowed through by current and generates a magnetic field that accelerates the working piston.

Setting tools usually have a receptacle for a fastening element, from which a fastening element received therein is transferred into the substrate along a working axis. For this, the working element is driven toward the fastening element along the working axis by the drive. U.S. Pat. No. 6,830,173 B2 discloses a setting tool with a drive, which has an electrical capacitor and a coil.

The object of the present invention is to provide a setting tool of the aforementioned type with which high efficiency and/or good setting quality are/is ensured.

The object is achieved with a preferably hand-held tool for working a substrate, having a stator and a working piston, which is intended to move relative to the stator along a working axis, also having a drive, which is intended to drive the working piston from a starting position along the working axis to the substrate, the drive comprising a piston coil arranged on the working piston and a first stator coil arranged on the stator, and the first piston coil being intended to enter the first stator coil during a movement of the working piston relative to the stator along the working axis.

An advantageous embodiment is characterized in that the piston coil has a piston coil axis and the first stator coil has a first stator coil axis, which is oriented parallel to the piston coil axis. The first stator coil axis preferably coincides with the piston coil axis. It is also preferred that the piston coil and the first stator coil can be supplied with current in the same direction in order to generate magnetic fields in the same direction and to accelerate the piston coil into the first stator coil. The drive particularly preferably has a second stator coil arranged on the stator, which is arranged offset relative to the first stator coil along the working axis and has a second stator coil axis, which is oriented parallel to the piston coil axis, with the piston coil and the second stator coil being able to be supplied with current in the same direction in order to generate magnetic fields in the same direction and to accelerate the piston coil into the second stator coil after the piston coil has been accelerated into the first stator coil. The piston coil is accelerated in the same direction relative to the first stator coil and relative to the second stator coil.

An advantageous embodiment is characterized in that the piston coil and the first stator coil can be supplied with current in opposite directions in order to generate opposing magnetic fields and to accelerate the piston coil out of the first stator coil. The drive preferably has a second stator coil arranged on the stator, which is arranged offset relative to the first stator coil along the working axis and has a second stator coil axis, which is oriented parallel to the piston coil axis, with the piston coil and the second stator coil being able to be supplied with current in opposite directions in order to generate opposing magnetic fields and to accelerate the piston coil out of the second stator coil after the piston coil has been accelerated out of the first stator coil. The piston coil is accelerated in the same direction relative to the first stator coil and relative to the second stator coil. The first stator coil and the second stator coil are preferably wound in the same direction relative to one another.

An advantageous embodiment is characterized in that the drive has a first capacitor, the first stator coil and/or the piston coil being electrically connectable to the capacitor in order during rapid discharge of the first capacitor to have a current flowing through it and to generate the magnetic field. The drive preferably has a second capacitor, the second stator coil and/or the piston coil being electrically connectable to the second capacitor in order during rapid discharge of the second capacitor to have a current flowing through it and to generate the magnetic field. The tool particularly preferably comprises a detection device for detecting a position of the working piston and a control device for supplying electrical current to the second stator coil in dependence on a position of the working piston detected by the detection device.

An advantageous embodiment is characterized in that the piston coil and the first stator coil are electrically connected to one another in series and are wound in the same direction or in opposite directions relative to one another.

An advantageous embodiment is characterized in that the piston coil has a piston coil outer diameter, and the first stator coil having a stator coil inner diameter which is larger than the piston coil outer diameter.

An advantageous embodiment is characterized in that the working piston comprises a reluctance element of a soft magnetic material which is accelerated into the first stator coil by the magnetic field that is generated by the first stator coil. The reluctance element preferably projects transversely to the working axis from the rest of the working piston toward the first stator coil.

An advantageous embodiment is characterized in that the tool is designed as a setting device for driving fastening elements into a substrate, having a receptacle which is intended to receive a fastening element, the working piston or the stator being intended to transfer a fastening element received in the receptacle into the substrate along the working axis, and the drive being intended to drive the working piston onto the fastening element along the working axis.

In the context of the invention, a capacitor should be understood as meaning an electrical component that stores electrical charge and the associated energy in an electrical field. In particular, a capacitor has two electrically conducting electrodes, between which the electrical field builds up when the electrodes are electrically charged differently. In the context of the invention, a fastening element should be understood as meaning for example a nail, a pin, a clamp, a clip, a stud, in particular a threaded stud, or the like.

A soft magnetic material in the context of the invention should be understood as meaning a material which has a high magnetic saturation flux density and in particular a small coercive field strength, and thus reinforces a magnetic field penetrating the material. In particular, the soft magnetic material of the stator frame and/or the piston frame has a saturation flux density of at least 1.0 T, preferably at least 1.3 T, particularly preferably at least 1.5 T. In the context of the invention, an electrically conductive material should be understood as meaning a material that has a high specific electrical conductivity, so that a magnetic field passing through the material generates eddy currents in the material. A soft magnetic and/or electrically conductive material preferably consists of a ferromagnetic material, particularly preferably a ferromagnetic metal, for example iron, cobalt, nickel, or an alloy with one or more ferromagnetic metals as the main component.

The invention is represented in a number of exemplary embodiments in the drawings, in which:

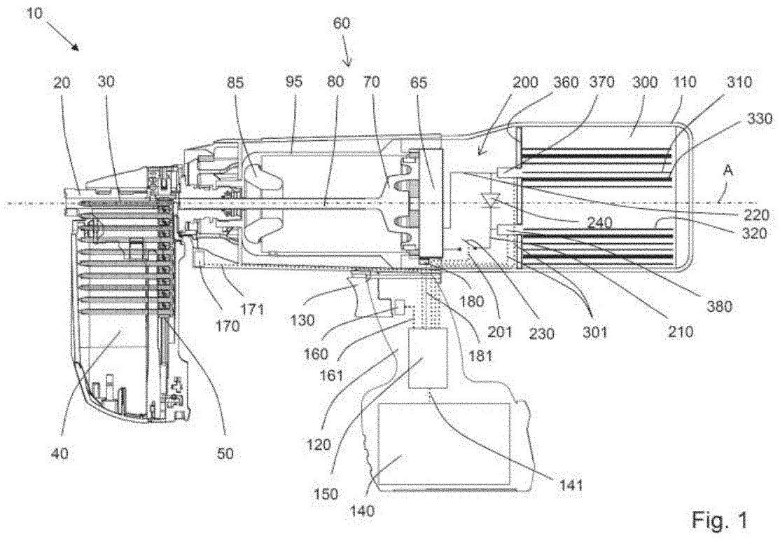

FIG. 1 shows a tool in a longitudinal section,

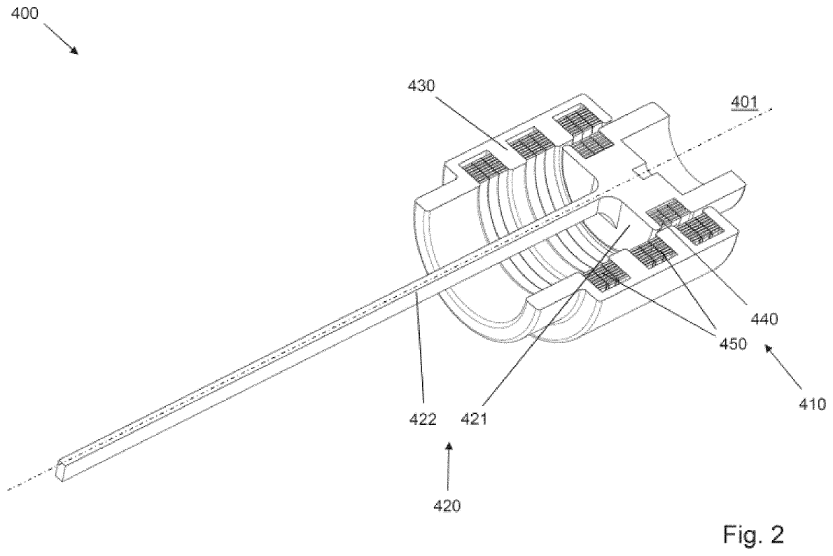

FIG. 2 shows a stator/working-piston unit of a tool in a perspective longitudinal section,

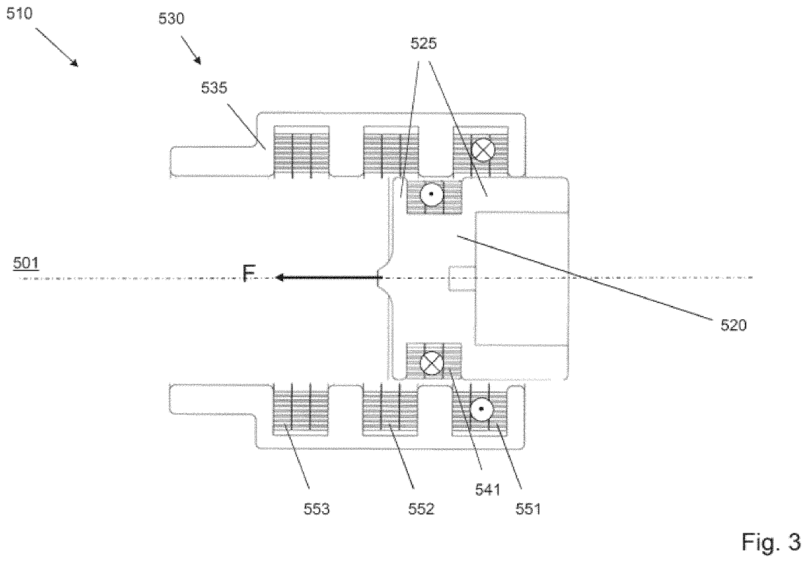

FIG. 3 shows a stator/working-piston unit of a tool in a longitudinal section,

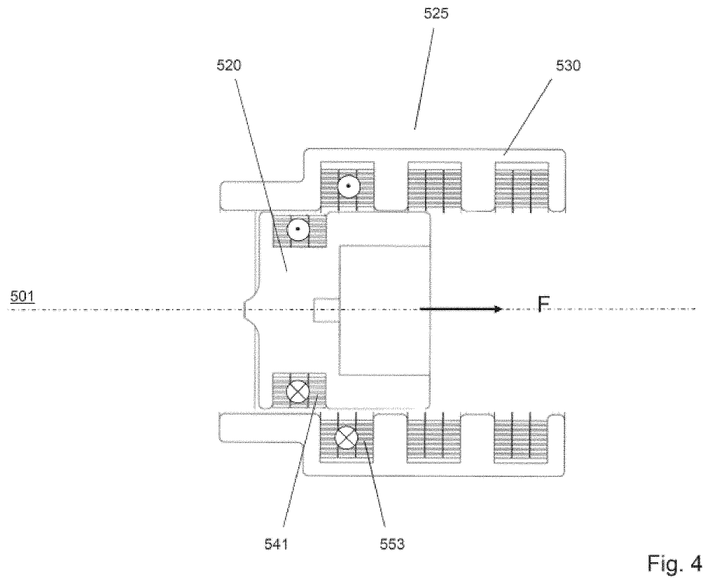

FIG. 4 shows a stator/working-piston unit of a tool in a longitudinal section, and

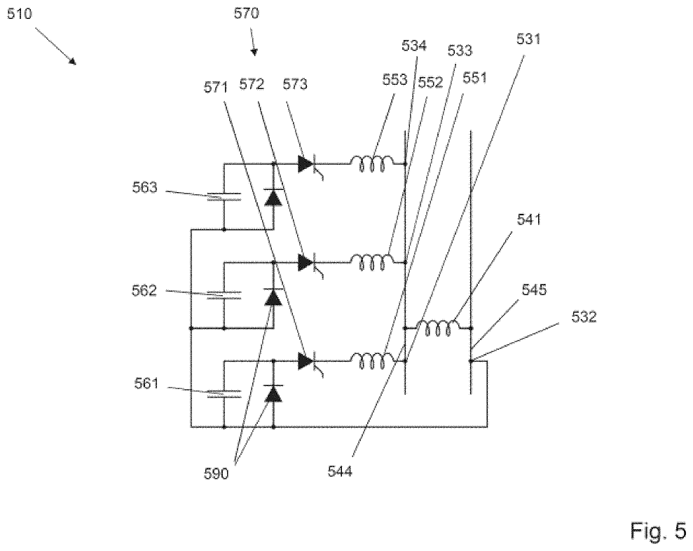

FIG. 5 shows an electrical circuit diagram of a drive.

In FIG. 1, a tool 10 for working a substrate (not shown), which is designed as a hand-held setting device for driving fastening elements into the substrate, is shown in a longitudinal section. The tool 10 has a receptacle 20 which is formed as a stud guide and in which a fastening element 30 formed as a nail is received in order to be driven into the substrate along a working axis A (to the left in FIG. 1). For feeding fastening elements to the receptacle, the tool 10 comprises a magazine 40 in which the fastening elements are received individually or collectively in the form of a fastening element strip 50 and are transported one by one into the receptacle 20. For this, the magazine 40 has a spring-loaded feed element, not specifically denoted.

The tool 10 has a working piston 60, which comprises a piston plate 70 and a piston rod 80. The working piston 60 is intended to transfer the fastening element 30 out of the receptacle 20 along the working axis A into the substrate. In the process, the working piston 60 is guided by its piston plate 70 in a guide cylinder 95 along the working axis A. In exemplary embodiments that are not shown, the working piston is guided along the working axis by two, three or more guide elements, for example guide rods. The working piston 60 is in turn driven by a drive 65, which comprises a switching circuit 200 and a capacitor 300. The switching circuit 200 is intended to bring about a rapid electrical discharge of the previously charged capacitor 300 and to feed the discharge current thereby flowing to the drive 65.

The tool 10 also comprises a housing 110, in which the drive 65 is received, a handle 120 with an actuating element 130 formed as a trigger, an electrical energy store 140 formed as a storage battery, a control unit 150, a trigger switch 160, a pressure switch 170, a temperature sensor 180 arranged on the drive 65 and electrical connecting lines 141, 161, 171, 181, 201, 301, which connect the control unit 150 to the electrical energy store 140, the trigger switch 160, the pressure switch 170, the temperature sensor 180, the switching circuit 200 and the capacitor 300. In exemplary embodiments that are not shown, the tool 10 is supplied with electrical energy by means of a power cable instead of the electrical energy store 140 or in addition to the electrical energy store 140. The control unit comprises electronic components, preferably interconnected on a printed circuit board to form one or more electrical control circuits, in particular one or more microprocessors.

When the tool 10 is pressed against a substrate that is not shown (to the left in FIG. 1), a contact-pressure element, not specifically denoted, actuates the contact-pressure switch 170, which as a result transmits a contact-pressure signal to the control unit 150 by means of the connecting line 171. Triggered by this, the control unit 150 initiates a capacitor charging process in which electrical energy is conducted by means of the connecting line 141 from the electrical energy store 140 to the control unit 150 and by means of the connecting lines 301 from the control unit 150 to the capacitor 300 in order to electrically charge the capacitor 300. For this purpose, the control unit 150 comprises a switching converter, not specifically denoted, which converts the electrical current from the electrical energy store 140 into a suitable charge current for the capacitor 300. When the capacitor 300 is charged and the working piston 60 is in its ready-to-set position shown in FIG. 1, the tool 10 is in a ready-to-set state. Since the charging of the capacitor 300 is only brought about by the tool 10 pressing against the substrate, to increase the safety of bystanders a setting process is only made possible when the setting tool 10 is pressed against the substrate. In exemplary embodiments that are not shown, the control unit already initiates the capacitor charging process when the tool is switched on or when the tool is lifted off the substrate or when a preceding driving-in process is completed.

When the actuating element 130 is actuated, for example by being pulled using the index finger of the hand holding the handle 120, with the tool 10 in the ready-to-set state, the actuating element 130 actuates the trigger switch 160, which as a result transmits a trigger signal to the control unit 150 by means of the connecting line 161. Triggered by this, the control unit 150 initiates a capacitor discharging process, in which electrical energy stored in the capacitor 300 is conducted by means of the switching circuit 200 from the capacitor 300 to the drive 65, in that the capacitor 300 is electrically discharged.

For this purpose, the switching circuit 200 schematically illustrated in FIG. 1 comprises two discharge lines 210, 220, which connect the capacitor 300 to the drive 65 and of which at least one discharge line 210 is interrupted by a normally open discharge switch 230. The switching circuit 200 with the drive 65 and the capacitor 300 may form an electrical oscillating circuit. Oscillation of this oscillating circuit back and forth and/or negative charging of the capacitor 300 may potentially have an adverse effect on the efficiency of the drive 65, but can be suppressed with the aid of a free-wheeling diode 240. The discharge lines 210, 220 are electrically connected in each case to an electrode 310, 320 of the capacitor 300 arranged on a carrier film 330 by means of electrical contacts 370, 380 of the capacitor 300 arranged on an end face 360 of the capacitor 300 facing the receptacle 20, for example by soldering, welding, screwing, clamping or a form fit. The discharge switch 230 is preferably suitable for switching a discharge current with a high current intensity and is formed for example as a thyristor. In addition, the discharge lines 210, 220 are at a small distance from one another, so that a parasitic magnetic field induced by them is as low as possible. For example, the discharge lines 210, 220 are combined to form a busbar and are held together by a suitable means, for example a holder or a clip. In exemplary embodiments that are not shown, the free-wheeling diode is connected electrically in parallel with the discharge switch. In further exemplary embodiments that are not shown, no free-wheeling diode is provided in the circuit.

To initiate the capacitor discharge process, the control unit 150 closes the discharge switch 230 by means of the connecting line 201, whereby a high-intensity discharge current of the capacitor 300 flows through the drive 65, which drives the working piston 60 toward the receptacle 20 and the fastening element 30 received therein. As soon as the piston rod 80 of the working piston 60 meets a head, not denoted any more specifically, of the fastening element 30, the fastening element 30 is driven into the substrate by the working piston 60. Excess kinetic energy of the working piston 60 is absorbed by a braking element 85 of a spring-elastic and/or damping material, for example rubber or an elastomer, by the working piston 60 moving with its piston plate 70 against the braking element 85 and being braked by the latter until it comes to a standstill. The working piston 60 is then reset to the ready-to-set position by a resetting device not denoted any more specifically.

In FIG. 2, a stator/working-piston unit 400 of a tool, for example the tool 10 shown in FIG. 1, is illustrated. The drive/working-piston unit 400 is shown cut away along a working axis 401 and comprises a partially shown drive 410, a working piston 420 and a stator 430. The working piston 420 has a piston body 421 and a piston rod 422 and is intended to move relative to the stator 430 along the working axis 401. The drive 410 is intended to drive the working piston 420 along the working axis 401. For this purpose, the drive 410 comprises a piston coil capacitor (not shown) and one or more stator coil capacitors (not shown) and a piston coil 440 arranged on the working piston 420 and a number of stator coils 450 arranged on the stator.

The piston coil 440 can be electrically connected to the piston coil capacitor in order during rapid discharge of the piston coil capacitor to have a current flowing through it and to generate a first magnetic field. The stator coils 450 can be electrically connected to the stator coil capacitor in order during rapid discharge of a stator coil capacitor in each case to have a current flowing through it and to generate second magnetic fields that interact with the first magnetic field and bring about timed repulsive forces between the piston coil 440 and one of the stator coils 450 in each case and to accelerate the working piston 420 along the working axis 401 out of the stator 430. Repulsive forces between the piston coil 440 and a respective stator coil 450 are brought about, for example by the magnetic field generated by the respective stator coil 450 being opposite to the magnetic field generated by the piston coil 440. For this purpose, the piston coil 440 and the stator coils 450 are preferably supplied with electrical current in opposite directions and one after the other by discharging the piston coil capacitor and the stator coil capacitors in a correspondingly timed manner, for example controlled by a control unit that is not shown. The piston coil 440 and the stator coils 450 respectively have a piston coil axis and a stator coil axis, which coincide with the working axis 401 and are thus oriented parallel to one another.

In FIG. 3, a drive 510 of a tool, for example the tool 10 shown in FIG. 1, is illustrated. The drive 510 is shown cut away along a working axis 501 and is intended to drive a working piston 520 with a piston body and a piston rod (not shown) along the working axis 501 and to move it relative to a stator 530. The drive 510 comprises a piston coil 541 arranged on the working piston 520, a first stator coil 551 arranged on the stator 530, a second stator coil 552 arranged on the stator 530 and a third stator coil 553 arranged on the stator 530. The piston coil 541 can be electrically connected to a piston coil capacitor (not shown) in order during rapid discharge of the capacitor to have a current flowing through it. A current flow through the piston coil 541 generates a first magnetic field. The stator coils 551, 552, 553 can be electrically connected in each case to a stator coil capacitor (not shown) in order during rapid discharge of the respective stator coil capacitor to have current flowing through them. A current flow through the stator coils 551, 552, 553 generates second magnetic fields.

The piston coil 541 and the stator coils 551, 552, 553 respectively have a piston coil axis and a stator coil axis, which coincide with the working axis 501 and are thus oriented parallel to one another. The piston coil 541 and the stator coils 551, 552, 553 are wound in the same direction. In exemplary embodiments that are not shown, the piston coil is wound in the opposite direction relative to the stator coils. The piston coil 541 and the stator coils 551, 552, 553 preferably have in each case the same number of coil turns, so that the magnetic fields generated by the coils 541, 551, 552, 553 are essentially equally strong.

The piston 520 preferably consists of a soft magnetic material, such as for example iron or an alloy thereof, for example steel. The stator 530 has a stator frame 535, which preferably consists of a soft magnetic material, such as for example iron or an alloy thereof, for example steel. The stator frame 535 surrounds the stator coils 551, 552, 553 and extends in a circumferential direction with respect to the working axis 501. As a result, the magnetic fields generated by the stator coils 551, 552, 553 are intensified in the area of the piston coil 541 and the accelerating force between the stator 530 and the working piston 520 is increased.

The drive 510 is intended to drive the working piston 520 forward from a starting position shown in FIG. 3 along the working axis 501 toward the substrate (to the left in FIG. 3). In the starting position, the piston coil 541 partially protrudes into the first stator coil 551 and is arranged offset forward relative to the first stator coil. In FIG. 3, the coils 541, 551 are provided with circle symbols, a point in the circle representing a current flow out of the plane of the drawing and a cross in the circle representing a current flow into the plane of the drawing. The piston coil 541 and the first stator coil 551 are supplied with current in opposite directions and therefore generate opposing magnetic fields, so that the piston coil 541 is accelerated forward out of the first stator coil 551. As soon as the piston coil 541 has completely entered the second stator coil 552, the piston coil 541 and the second stator coil 552 are supplied with current in opposite directions, so that the piston coil 541 is accelerated even further forward out of the second stator coil 552 after the piston coil 541 has been accelerated out of the first stator coil 551. As soon as the piston coil 541 has completely entered the third stator coil 553, the piston coil 541 and the third stator coil 553 are supplied with current in opposite directions, so that the piston coil 541 is accelerated further forward out of the third stator coil 553 after the piston coil 541 has been accelerated out of the second stator coil 552.

Altogether, the piston coil 541 is accelerated forward three times in succession. In exemplary embodiments that are not shown, the piston coil in the starting position is arranged offset backward relative to the first stator coil and the piston coil and the first stator coil are supplied with electrical current in the same direction, so that the piston coil is accelerated into the first stator coil. The piston coil 541 has a piston coil outer diameter which is larger than a stator coil inner diameter of the first stator coil 551. As the working piston 520 moves forward, the piston coil 541 enters the second stator coil 552 and passes completely through the second stator coil 552, as well as through the third stator coil 553.

The working piston 520 has two reluctance elements 525 of a soft magnetic material, which are formed as circumferential projections of the working piston 520. In the starting position of the working piston 520 shown in FIG. 3, the reluctance elements 525 are in each case accelerated into the respective stator coil 551, 552, 553 by a magnetic field that is generated by one of the stator coils 551, 552, 553. This increases an overall forward acceleration of the working piston 520.

As a result of the piston coils 541, 542, 543 entering one another, a power transmission takes place over a relatively long time and/or a relatively long distance covered by the working piston 520, so that a relatively small maximum force is required for sufficient energy transmission. This reduces mechanical loads on all components of the drive 510. In addition, a relatively small maximum current is required. In addition, the resulting waste heat is distributed over several coils, which facilitates cooling of the drive 519.

In FIG. 4, the working piston 520 and the stator 530 are illustrated in a first end position of the working piston 520 along the working axis 501. The piston coil 541 is arranged offset forward relative to the third stator coil 553 along the working axis 501. By supplying current to the first piston coil 541 and the third stator coil 553 in the same direction, it is possible to accelerate the working piston 520 backward in order to move it into the starting position. This requires polarity reversal or separate energization of the piston coil 541 or the third stator coil 553.

In FIG. 5, an electrical circuit diagram of the drive 510 shown in FIG. 3 is illustrated. The drive 510 comprises a first capacitor 561, a second capacitor 562, a third capacitor 563, a switching circuit 570 with three free-wheeling diodes 590, a first switch 571, a second switch 572 and a third switch 573, a piston coil 541 arranged on the working piston, a first stator coil 551 arranged on the stator, a second stator coil 552 arranged on the stator, and a third stator coil 553 arranged on the stator. The piston coil 541 can be electrically connected to each capacitor 561, 562, 563 in order during rapid discharge of the respective capacitor 561, 562, 563 to have a current flowing through it, so that each of the capacitors 561, 562, 563 represents a piston coil capacitor. The stator coils 551, 552, 553 can also be electrically connected in each case to one of the capacitors 561, 562, 563 in order during rapid discharge of the respective capacitor 561, 562, 563 to have a current flowing through them, so that each of the capacitors 561, 562, 563 also represents a stator coil capacitor.

The first capacitor 561 is electrically connected to an input of the first switch 571. An output of the first switch 571 is electrically connected, preferably permanently wired, to an input of the first stator coil 551. An output of the first stator coil 551 is electrically connected, preferably permanently wired, to a first electrical stator contact 531, which is formed as a contact brush. The second capacitor 562 is electrically connected to an input of the second switch 572. An output of the second switch 572 is electrically connected, preferably permanently wired, to an input of the second stator coil 552. An output of the second stator coil 552 is electrically connected, preferably permanently wired, to a second electrical stator contact 533, which is formed as a contact brush. The third capacitor 563 is electrically connected to an input of the third switch 573. An output of the third switch 573 is electrically connected, preferably permanently wired, to an input of the third stator coil 553. An output of the third stator coil 553 is electrically connected, preferably permanently wired, to a third electrical stator contact 534, which is formed as a contact brush.

An input of the piston coil 541 is electrically connected, preferably permanently wired, to a first piston contact 544, which is formed as a contact rail and which the working piston has. The first piston contact 544 slides in an electrically conducting manner along the stator contacts 531, 533, 543 when the working piston moves along the working axis. One or more first springs (not shown) load the stator contacts 531, 533, 534 toward the first piston contact 544. In exemplary embodiments that are not shown, a spring additionally or alternatively loads the first piston contact toward the first stator contact. An output of the piston coil 541 is electrically connected, preferably permanently wired, to a second piston contact 545, which is formed as a contact rail and which the working piston has. The second piston contact 545 slides in an electrically conducting manner along a ground contact 532 when the working piston moves along the working axis. The stator 530 has the ground contact 532, which is formed as a contact brush and is electrically connected to a ground potential (not shown), to which the capacitors 561, 562, 563 are also electrically connected. A second spring (not shown) loads the ground contact 532 toward the second piston contact 545. In exemplary embodiments that are not shown, a spring additionally or alternatively loads the second piston contact toward the ground contact. The piston contacts 544, 545 are rigidly connected to the rest of the working piston and move with the rest of the working piston. In exemplary embodiments that are not shown, the first and/or the second stator contact is formed as a slip ring.

The respective rapid discharge of the capacitors 561, 562, 563 via the piston coil 541 and the stator coils 551, 552, 553 can be triggered by means of the switching circuit 570, by firstly the first switch 571 being closed when the first capacitor 561 is electrically charged and the first stator coil 551 and the piston coil 541 being electrically connected to the first capacitor 561. The electrical current then flows from the first capacitor 561 through the first switch 571, through the first stator coil 551, through the first stator contact 531 and the first piston contact 544, through the piston coil 541 and finally through the second piston contact 545 and the ground contact 532 to the first capacitor 561. As soon as the piston coil 541 has completely entered the second stator coil 552, the second switch 572 is closed when the first capacitor 562 is electrically charged and the second stator coil 552 and the piston coil 541 are electrically connected to the second capacitor 562. The electrical current then flows from the second capacitor 562 through the second switch 572, through the second stator coil 552, through the second stator contact 533 and the first piston contact 544, through the piston coil 541 and finally through the second piston contact 545 and the ground contact 532 to the second capacitor 562. As soon as the piston coil 541 has completely entered the third stator coil 553, the third switch 573 is closed when the third capacitor 563 is electrically charged and the third stator coil 553 and the piston coil 541 are electrically connected to the third capacitor 563. The electrical current then flows from the third capacitor 563 through the third switch 573, through the third stator coil 553, through the third stator contact 534 and the first piston contact 544, through the piston coil 541 and finally through the second piston contact 545 and the ground contact 532 to the third capacitor 563.

The invention has been described using a series of exemplary embodiments that are illustrated in the drawings and exemplary embodiments that are not illustrated. The individual features of the various exemplary embodiments are applicable individually or in any desired combination with one another, provided that they are not contradictory. It is pointed out that the tool according to the invention can also be used for other applications, for example as a hammer drill or the like.

1. A tool for working a substrate, the tool having a stator and a working piston, which is intended to move relative to the stator along a working axis, also having a drive, which is intended to drive the working piston from a starting position along the working axis to the substrate, the drive comprising a piston coil arranged on the working piston and a first stator coil arranged on the stator, and the first piston coil being intended to enter the first stator coil during a movement of the working piston relative to the stator along the working axis.

2. The tool as claimed in claim 1, the piston coil having a piston coil axis and the first stator coil having a first stator coil axis, which is oriented parallel to the piston coil axis.

3. The tool as claimed in claim 2, with the piston coil and the first stator coil being able to be supplied with current in the same direction in order to generate magnetic fields in the same direction and to accelerate the piston coil into the first stator coil.

4. The tool as claimed in claim 3, the drive having a second stator coil arranged on the stator, which is arranged offset relative to the first stator coil along the working axis and has a second stator coil axis, which is oriented parallel to the piston coil axis, with the piston coil and the second stator coil being able to be supplied with current in the same direction in order to generate magnetic fields in the same direction and to accelerate the piston coil into the second stator coil after the piston coil has been accelerated into the first stator coil, the piston coil being accelerated in the same direction relative to the first stator coil and relative to the second stator coil.

5. The tool as claimed in claim 2, the piston coil and the first stator coil being able to be supplied with current in opposite directions in order to generate opposing magnetic fields and to accelerate the piston coil out of the first stator coil.

6. The tool as claimed in claim 5, the drive having a second stator coil arranged on the stator, which is arranged offset relative to the first stator coil along the working axis and has a second stator coil axis, which is oriented parallel to the piston coil axis, with the piston coil and the second stator coil being able to be supplied with current in opposite directions in order to generate opposing magnetic fields and to accelerate the piston coil out of the second stator coil after the piston coil has been accelerated out of the first stator coil, the piston coil being accelerated in the same direction relative to the first stator coil and relative to the second stator coil.

7. The tool as claimed in claim 4, the first stator coil and the second stator coil being wound in the same direction relative to one another.

8. The tool as claimed in claim 1, the drive having a first capacitor, the first stator coil and/or the piston coil being electrically connectable to the capacitor in order during rapid discharge of the first capacitor to have a current flowing through it and to generate the magnetic field.

9. The tool as claimed in claim 8, the drive having a second capacitor, the second stator coil and/or the piston coil being electrically connectable to the second capacitor in order during rapid discharge of the second capacitor to have a current flowing through it and to generate the magnetic field.

10. The tool as claimed in claim 4, comprising a detection device for detecting a position of the working piston and a control device for supplying electrical current to the second stator coil in dependence on a position of the working piston detected by the detection device.

11. The tool as claimed in claim 1, the piston coil and the first stator coil being electrically connected to one another in series and wound in the same direction or in opposite directions relative to one another.

12. The tool as claimed in claim 1, the piston coil having a piston coil outer diameter, and the first stator coil having a stator coil inner diameter which is larger than the piston coil outer diameter.

13. The tool as claimed in claim 1, the working piston comprising a reluctance element of a soft magnetic material, which is accelerated into the first stator coil by the magnetic field that is generated by the first stator coil.

14. The tool as claimed in claim 13, the reluctance element projecting transversely to the working axis from the rest of the working piston toward the first stator coil.

15. The tool as claimed in claim 1, having a receptacle which is intended to receive a fastening element, the working piston or the stator being intended to transfer a fastening element received in the receptacle into the substrate along the working axis.

16. The tool of claim 2, wherein the first stator axis coincides with the piston coil axis.

17. The tool as claimed in claim 3, the piston coil and the first stator coil being able to be supplied with current in opposite directions in order to generate opposing magnetic fields and to accelerate the piston coil out of the first stator coil.

18. The tool as claimed in claim 5, the first stator coil and the second stator coil being wound in the same direction relative to one another.

19. The tool as claimed in claim 6, comprising a detection device for detecting a position of the working piston and a control device for supplying electrical current to the second stator coil in dependence on a position of the working piston detected by the detection device.

20. The tool as claimed in claim 2, the piston coil and the first stator coil being electrically connected to one another in series and wound in the same direction or in opposite directions relative to one another.
